(19) United States
(12) Patent Application Publication
(10) Pub. No.: US 2018/0285959 A1
(43) Pub. Date: Oct. 4, 2018

(54) PRODUCT RECOMMENDATION ENGINE FOR CONSUMER INTERFACE OF UNATTENDED RETAIL POINTS OF SALE

(71) Applicant: Crane Merchandising Systems, Inc., Williston, SC (US)

(72) Inventors: Sharon Peyer, Lincoln, MA (US); William C. Royal, Oak Ridge, NC (US); Ignacio Santa Cruz, St. Louis, MO (US); Benjamin Holmes, North Augusta, SC (US)

(21) Appl. No.: 15/940,746

(22) Filed: Mar. 29, 2018

Related U.S. Application Data
(60) Provisional application No. 62/478,946, filed on Mar. 30, 2017.

(51) Int. Cl. G06Q 30/06; G07F 11/00; G06Q 20/20; G07F 9/00

(52) U.S. Cl. CPC G06Q 30/0631; G06Q 30/0633; G07F 9/006; G06Q 20/203; G07F 11/002

(57) ABSTRACT

A vending machine (105) includes an enclosure configured to store products for a vending transaction. A user interface (215) of the vending machine (105) is configured to display, on a display screen, content for viewing and a recommendation for one or more products. Content includes one or more of a poll, an advertisement, a product selection menu, a payment selection menu, a product purchase display queue, or a transaction complete display queue. A control system (300) is configured to receive at least one recommendation input based on displaying the content, product information of one or more products, and at least one recommendation rule. The control system (300) is also configured to generate for display, on the display screen, the recommendation for one or more products based on the at least one recommendation input, the product information of the one or more products, and the at least one recommendation rule.

### CROSS-REFERENCE TO RELATED APPLICATION AND CLAIM OF PRIORITY

This application claims priority under 35 U.S.C. § 119(e) to U.S. Provisional Patent Application No. 62/478,946 filed on Mar. 30, 2017, which is hereby incorporated by reference in its entirety.

### TECHNICAL FIELD

This disclosure is generally directed to vending machines. More specifically, this disclosure is directed to a product recommendation engine in a vending machine.

### BACKGROUND

Vending machines offer unattended sales of commodities such as snacks, canned or bottled beverages, or any of a variety of other articles. However, vending machines, when placed into service in the field, have historically been unable to leverage their powerful digital media, their shopping carts for multiple vends, or their cashless payment features. Consequently, vending machines continue to suffer flat revenue streams.

### SUMMARY

The present disclosure provides a product recommendation engine for a consumer interface of an unattended retail point of sale terminal, such as a vending machine.

In one aspect thereof, an unattended retail point of sale terminal implementing a product recommendation engine is provided. The unattended retail point of sale terminal includes an enclosure configured to store one or more products for a vending transaction. The unattended retail point of sale terminal also includes a user interface configured to display, on a display screen, content for viewing by a customer and a recommendation for one or more products. The content includes one or more of a poll, an advertisement, a product selection menu, a payment selection menu, a product purchase display queue for displaying products that have been selected for purchase, or a transaction complete display queue. The unattended retail point of sale terminal further includes a control system configured to receive at least one recommendation input based on displaying the content, product information of one or more products, and at least one recommendation rule. The control system is also configured to generate for display, on the display screen, the recommendation for one or more products based on the at least one recommendation input, the product information of the one or more products, and the at least one recommendation rule.

In another aspect thereof, a method implemented by a product recommendation engine of an unattended retail point of sale terminal is provided. The method includes storing one or more products for a vending transaction within an enclosure of a vending machine. The method also includes displaying content on a display screen of a user interface, the content including one or more of a poll, an advertisement, a product selection menu, a payment selection menu, a product purchase display queue, or a transaction complete display queue. The method further includes receiving at least one recommendation input based on displaying the content, product information of one or more products, and at least one recommendation rule. In addition, the method includes displaying a recommendation for one or more products based on the at least one recommendation input, the product information of the one or more products, and the at least one recommendation rule.

In another aspect thereof, an unattended retail point of sale terminal implementing a product recommendation engine is provided. The unattended retail point of sale terminal includes an enclosure configured to store one or more products for a vending transaction. The unattended retail point of sale terminal also includes a user interface configured to display, on a display screen, content for viewing by a customer and a recommendation for one or more products. The content includes one or more of a poll, an advertisement, a product selection menu, a payment selection menu, a product purchase display queue, or a transaction complete display queue. The unattended retail point of sale terminal further includes a control system configured to receive at least one recommendation input based on displaying the content, product information of one or more products, and at least one recommendation rule. One or more of the at least one recommendation input, the product information of the one or more products, or the at least one recommendation rule is received from a server via wireless communication with the unattended retail point of sale terminal. The control system is also configured to generate for display, on the display screen, the recommendation for one or more products based on the at least one recommendation input, the product information of the one or more products, and the at least one recommendation rule.

Other technical features may be readily apparent to one skilled in the art from the following figures, descriptions, and claims.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure, reference is now made to the following description, taken in conjunction with the accompanying drawings, in which:

FIG. 1 illustrates a vending network including a vending machine that implements a product recommendation engine to provide a recommendation according to embodiments of the present disclosure;

FIG. 2 illustrates a vending machine that implements a product recommendation engine to provide a recommendation according to embodiments of the present disclosure;

FIG. 3 illustrates a block diagram of selected electrical and electronic components of the vending machine in FIG. 2;

FIG. 4 illustrates a product selection menu for display on a consumer user interface according to embodiments of the present disclosure;

FIG. 5 illustrates a recommendation for presentation to a customer or a potential customer of a vending machine according to embodiments of the present disclosure;

FIG. 6 illustrates a product purchase display queue presented on a user interface of a vending machine according to embodiments of the present disclosure;

FIG. 7 illustrates another product purchase display queue presented on a user interface of a vending machine according to embodiments of the present disclosure; and

FIG. 8 illustrates a method of providing a recommendation by a vending machine controller (VMC), implementing a product recommendation engine, during operation of a vending machine according to embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. The phrase “at least one of,” when used with a list of items, means that different combinations of one or more of the listed items may be used, and only one item in the list may be needed. Definitions for certain words and phrases are provided throughout this patent document, those of ordinary skill in the art should understand that in many, if not most instances, such definitions apply to prior, as well as future uses of such defined words and phrases.

### DETAILED DESCRIPTION

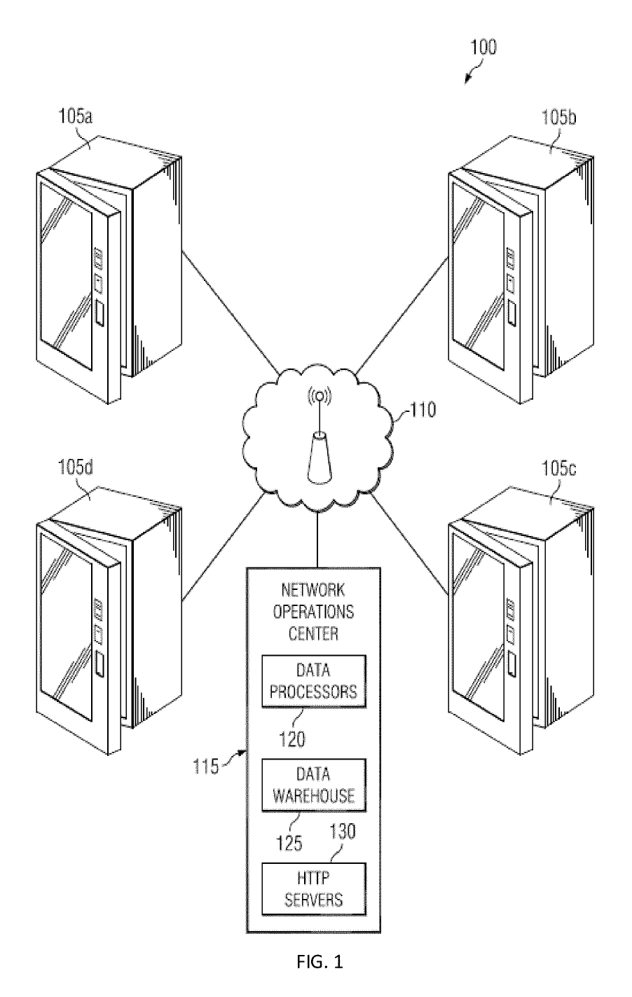

FIGS. 1 through 8, described below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device or system.

FIG. 1 illustrates a vending network 100 including a vending machine that implements a product recommendation engine to provide a recommendation according to embodiments of the present disclosure. Although certain details will be provided with reference to the components of a vending network 100 of FIG. 1, it should be understood that other embodiments may include more, less, or different components. The vending network 100 includes a plurality of vending machines 105a, 105b, 105c, and 105d. Each of the vending machines 105a through 105d is coupled to a data communications system 110. In certain embodiments, the vending network 100 includes one vending machine 105 coupled to the data communication system 110. That is, one or more of the vending machines 105 are not directly coupled to the data communications system 110. The data communications system 110 facilitates data communications between at least one vending machine 105 and a central facility, such as a network operations center 115.

The data communications system 110 can be implemented in a known manner, such as by utilizing any one or combination of: an Internet Protocol (IP), a HyperText Transmission Protocol (HTTP) communication over the Internet (e.g., the world wide web), or secured by authentication and encryption processes to create a Virtual Private Network (VPN). One or more of the vending machines 105a through 105d communicate with the data communications system 110 using a wireless communication, wired communication, or a combination of wired and wireless communications. The communications between the data communications system 110 and the vending machines 105a through 105d can utilize known IP or HTTP access and communication methods. As described herein, one or more of the vending machines 105a through 105d can communicate product information of products stored in one or more of the vending machines 105a through 105d or a remaining quantity of each product stored in one or more of the vending machines 105a through 105d with one or more of the other vending machines 105a through 105d through the data communications system 110.

The network operations center 115 includes a number of components such as data processors 120, a data warehouse 125, and Hypertext Transfer Protocol (HTTP) servers 130. Accordingly, using the communications provided by the data communications system 110, the vending machines 105a through 105d connect to the network operations center 115 and the components contained within the network operations center 115. In certain embodiments, the data processors 120 are connected to the data warehouse 125 and the HTTP servers 130. The data processors 120 send and receive data to and from the data warehouse 125 and the HTTP servers 130. The data processors 120 perform calculations using the data received from the data warehouse 125, the HTTP servers 130, or both. In certain embodiments, one or more of the vending machines 105a through 105d send and receive data to the data processors 120. In certain embodiments, one or more of the vending machines 105a through 105d send and receive data to the data warehouse 125. The data warehouse 125 is capable of storing data in databases, such as rich structured query language (“SQL”) databases. For example, the data warehouse 125 is capable of storing passive or interactive advertisements for display, polls for display, selection menus for display, payment menus for display, product purchase display queues, transaction complete display queues, one or more recommendation rules, one or more recommendation inputs, or one or more recommendations, as described herein, for transmission to one or more of the vending machines 105a through 105d. Through a connection with the HTTP servers 130, one or more of the vending machines 105a through 105d connects to the Internet (e.g., the world wide web) and accesses websites and retrieves data therefrom. For example, one or more of the vending machines 105a through 105d may connect to the internet through a connection with an HTTP server 130 to receive one or more recommendation inputs, as described herein.

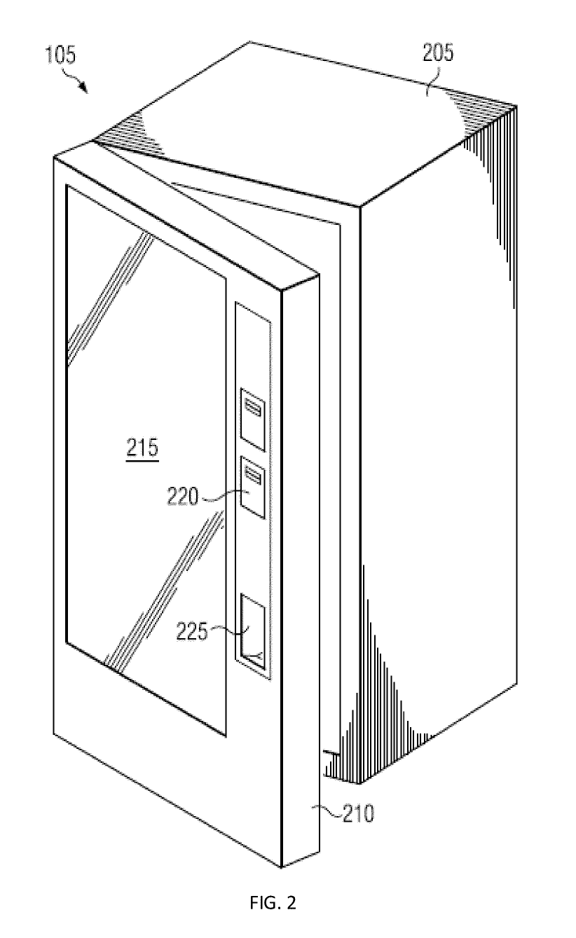

FIG. 2 illustrates a vending machine that implements a product recommendation engine to provide a recommendation according to embodiments of the present disclosure. Although certain details will be provided with reference to the components of the vending machine 105 of FIG. 2, it should be understood that other embodiments may include more, less, or different components. It should also be understood that although vending machine 105 is illustrated here by example, vending machine 105 represents any one of the vending machines 105a through 105d.

The vending machine 105 is configured to store a plurality of products for sale via a vending operation. The vending machine 105 includes a cabinet 205 and a service door 210. The cabinet 205 and the service door 210 form an enclosure, in which the plurality of products is stored. For some vending machines, the service door 210 is pivotally mounted along a front edge of the cabinet 205, and spans the entire front face of the vending machine 105. For other vending machines, the service door 210 extends only across a portion of the front of the vending machine 105, and is formed in two portions of equal or unequal sizes. The two portions of such service doors can be mounted to swing open in opposite directions.

The vending machine 105 includes a user interface 215. The user interface 215 is located on a front face of the vending machine 105, such as on a front portion of the cabinet 205 or on the service door 210. The user interface 215 includes a display configured to render information in video format, graphical format, textual format, or a combination thereof. Preferably, the display is a touch display screen, such as a liquid crystal display (“LCD”) screen with user touch detection. For example, the display can display a passive or an interactive advertisement, a poll, a product selection menu, a payment selection menu, a product selection display queue, a transaction complete display queue, or a recommendation, as described herein. In certain embodiments, the display also receives one or more recommendation inputs, as described herein.

The vending machine 105 includes a payment system 220. The payment system 220 is located on a front face of the vending machine 105, such as on a front portion of the cabinet 205 or on the service door 210. In certain embodiments, the payment system 220 is included within or as part of the user interface 215. The payment system 220 includes one or more of a bill validator, a coin acceptor, a credit or debit card reader, and a cashless payment device reader, such as a reader of fobs, tags, tokens, or quick-response codes (QR codes). The payment system 220 receives currency, coins, or other forms of payment from the customer and returns change as necessary. In certain embodiments, the payment system 220 includes a light for each payment device contained therein that indicates the status of that payment device to a user.

The vending machine 105 includes an access port 225 located on the front face of the enclosure, such as within the service door 210. The access port 225 enables access to a delivery receptacle mounted within the service door 210 or in the cabinet 205. The access port 225 can have a delivery door or other mechanical system (e.g., rotatable delivery receptacle open on one side) for controlling and restricting customer access into the delivery receptacle, an interior of the vending machine, or both. In certain embodiments, particularly when the vending machine 105 is configured as a helical coil snack vending machines, the access port 225 is located at or near a bottom of the vending machine and extends across most of a width of the vending machine 105. In certain embodiments, the access port 225 is disposed below a large glass window allowing a view of products within the cabinet 205 or below a large LCD screen that selectively presents images or videos. In certain embodiments, the aforementioned large LCD screen is the LCD screen of the user interface 215. In certain embodiments, the vending machine 105 includes X-Y product retrieval and delivery mechanisms and a glass or substantially transparent front or a large LCD screen front, but may also include the access port 225 disposed to the side, at a height convenient to the customer for product retrieval without bending over.

Those skilled in the art will recognize that the complete structure of a vending machine 105 is not illustrated in the drawings, and the complete details of the structure and operation of the vending machine 105 is not described in the present disclosure. Instead, for simplicity and clarity, only so much of the structure and operation of the vending machine 105 as is unique to the present disclosure or necessary for an understanding of the present disclosure is illustrated and described.

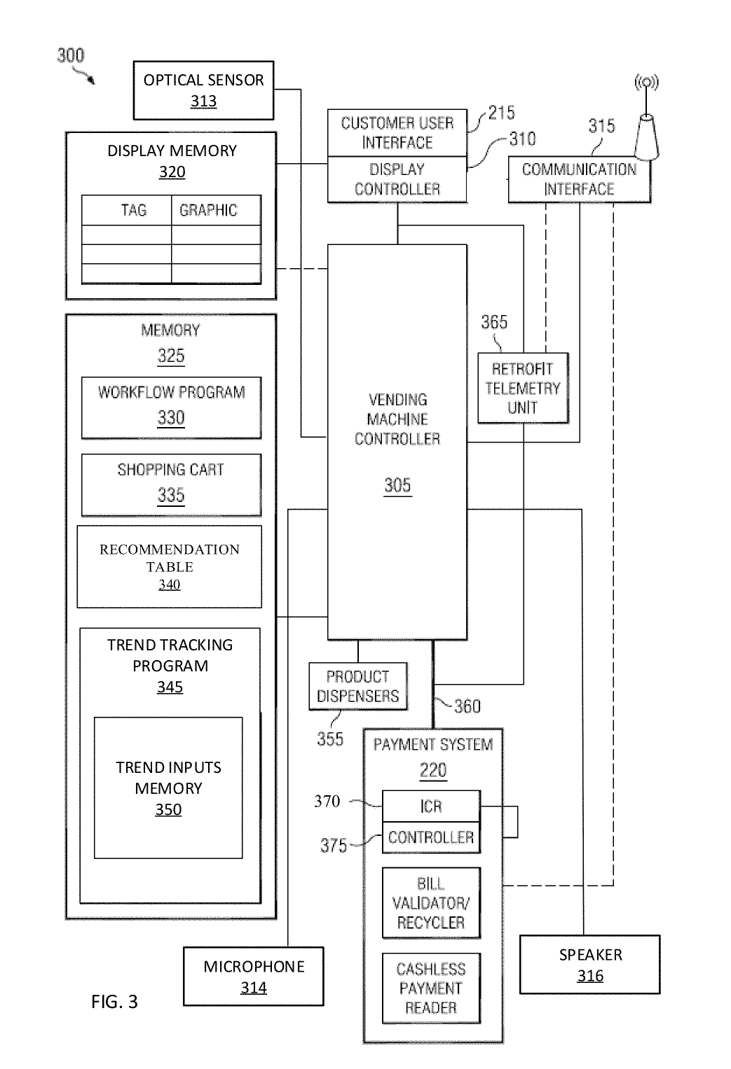

FIG. 3 illustrates a block diagram of selected electrical and electronic components of the vending machine 105 in FIG. 2. Although certain details will be provided with reference to the components of the control system 300 of FIG. 3, it should be understood that other embodiments may include more, less, or different components. The vending machine 105 includes the control system 300. The control system 300 is configured to enable the vending machine 105 to present a recommendation to a customer or a potential customer.

The control system 300 includes a programmable vending machine controller (“VMC”) 305. The VMC 305 is configured to control one or more functions of the vending machine 105. For example, the VMC 305 controls vending operation of the vending machine 105. As described herein, the VMC 305 includes processing circuitry for implementing a product recommendation engine to select and present a recommendation to a customer or a potential customer.

The VMC 305 is coupled to and communicates with a display controller 310. The display controller 310 is further coupled to the user interface 215. For example, the display controller 310 provides content for display on the user interface 215. In certain embodiments, content includes a passive or an interactive advertisement, a poll, a product selection menu, a payment selection menu, a product purchase display queue for displaying products that have been selected for purchase, or a transaction complete display queue for displaying products that have been purchased after completing a transaction. In certain embodiments, the display controller 310 provides recommendations for display on the user interface 215. The display controller 310 is configured to detect the location of the physical contact with the touch screen. For example, the display controller 310 detects a physical contact of a human, such as the customer, with the touch screen. The display controller 310 is configured to detect the location of the physical contact with the touch screen. According to the present disclosure, certain content for display includes one or more user controls (e.g., buttons, keys) that upon physical contact provide specific input to the control system 300.

In certain embodiments, the display controller 310 detects a recommendation input via physical contact from a customer or a potential customer on the touch screen when the user interface 215 provides content for display. In response, the display controller 310 transmits the recommendation input to the VMC 305, implementing the product recommendation engine, for use in selecting a recommendation. For example, the touch screen displays a poll soliciting a preference for bananas or strawberries. In response, the display controller 310 detects a physical contact with the touch screen at a location on the touch screen indicative of a preference for bananas over strawberries. The display controller 310 transmits the indication of the preference for bananas over strawberries to the VMC 305, implementing the product recommendation engine, for use in selecting a recommendation.

Display controller 310 is designed and configured to ensure that every key press and customer interaction (e.g., actuation of a user control) is deliberate. The display controller 310 is configured to provide content for display prior to a detection of customer contact, such as in an idle mode, a stand-by mode, a polling mode, or an advertising mode of the vending machine 105. In certain embodiments, the display controller 310 is configured to provide content for display in response to receiving a recommendation input, described herein. Additionally, or alternatively, the display controller 310 provides content for display in response to one or more vending machine events, such as a customer contact, a tender of payment, a dispensing operation, a refund operation, or the like.

The display controller 310 is coupled to and communicates with a display memory 320. The display memory 320 stores content for display on the user interface 215, such as screen displays and videos. The display memory 320 may also store recommendation for display on the user interface 215. The display memory 320 may include any suitable volatile or non-volatile storage and retrieval device(s). For example, the display memory 320 can include any electronic, magnetic, electromagnetic, optical, electro-optical, electro-mechanical, or other physical device(s) that can contain, store, communicate, propagate, or transmit information. The display memory 320 can store data and instructions for use by the display controller 310. For example, the instructions stored in the display memory 320 are configured to cause the display controller 310 to display graphical or textual information on the user interface 215. During a vend transaction and between transactions, the display controller 310 accesses the content or a recommendation for display stored in display memory 320. The display controller 310 renders screen displays and videos on the user interface 215 based on the accessed content for display.

The VMC 305 is optionally coupled to and communicates with the display memory 320. In certain embodiments, the content for display or recommendation, such as screen display graphics and videos, is stored in display memory 320 in exclusive association with a “tag”, or unique identifier, employed to access the respective content for display on the user interface 215.

In certain embodiments, the vending machine 105 includes or is configured to couple with an optical sensor 313. The optical sensor 313 is configured to detect activity or visually capture activity within a distance of the vending machine 105. The VMC 305 is coupled to and communicates with the optical sensor 313. Thus, when the optical sensor 313 detects activity or visually captures activity within a distance of the vending machine 105, the VMC 305 receives data from the optical sensor 313 based on the detected or visually captured activity. In certain embodiments, the VMC 305, implementing the product recommendation engine, can receive a recommendation input in the form of data from the optical sensor 313. In certain embodiments, the VMC 305, implementing the product recommendation engine, generates content for display in response to receiving data from the optical sensor 313 or based on a characteristic of the received data. Additionally or alternatively, when the optical sensor 313 detects an activity or visually captures activity within the distance of the vending machine 105, the VMC 305, implementing the product recommendation engine, initiates a microphone 314 described herein.

In certain embodiments, the optical sensor 313 includes a camera. The camera captures an image or records a video of a viewable activity within a distance of the vending machine 105. The VMC 305, implementing the product recommendation engine, receives data from the camera based on the image or the video of the viewable activity and identifies one or more viewable characteristics from the image or the video. A viewable characteristic includes an action, a movement, an item, an item quantity, a customer, a customer count, a human traffic trend, or the like from the image or video. In certain embodiments, the VMC 305, implementing the product recommendation engine, uses a viewable characteristic received from the camera to generate content for display.

The VMC 305, implementing the product recommendation engine, receives, via the camera, a captured image or recorded video of a viewable activity within a distance of the vending machine 105 and identifies or calculates a recommendation input within the captured image or the recorded video. For example, the user interface 215 displays content for viewing by one or more customers or potential customers. The camera captures an image or records a video of one or more customers or potential customers approaching the vending machine 105, viewing the user interface 215 of the vending machine 105, or standing in front of the vending machine 105. The VMC 305, implementing the product recommendation engine, receives the image or the video and identifies or calculates one or more recommendation inputs in the image or the video. The VMC 305, implementing the product recommendation engine, uses the recommendations input from the image or the video to select and present a recommendation to a customer or a potential customer.

Additionally or alternatively, the optical sensor 313 includes a motion sensor. The motion sensor detects motion within a distance of the vending machine 105. For example, the motion sensor detects when a customer or potential customer approaches the vending machine 105 based on movement of the customer or potential customer at or near the vending machine 105. The VMC 305, implementing the product recommendation engine, identifies a recommendation input based on motion detected by the motion sensor to select and present a recommendation to a customer or a potential customer. In certain embodiments, the VMC 305, implementing the product recommendation engine, generates content for display in response to the motion sensor detecting motion. In certain embodiments, when the motion sensor detects motion within the distance of the vending machine 105, the VMC 305, implementing the product recommendation engine, initiates the camera to capture an image or record a video, as described herein.

In certain embodiments, the vending machine 105 includes or is configured to couple with a microphone 314. The microphone 314 is configured to detect sound within a distance of the vending machine 105. The VMC 305 is coupled to and communicates with the microphone 314. Thus, when the microphone 314 detects sound within a distance of the vending machine 105, the VMC 305 receives data from the microphone 314 based on the detected sound. In certain embodiments, the VMC 305, implementing the product recommendation engine, generates content for display in response to receiving data from the microphone 314 or based on a specific sound identified by the VMC 305. Additionally or alternatively, when the microphone 314 detects a sound within the distance of the vending machine 105, the VMC 305, implementing the product recommendation engine, initiates the optical sensor 313 described herein.

The VMC 305, implementing the product recommendation engine, receives a recommendation input in the form a sound via the microphone 314. For example, the user interface 215 displays content for viewing by one or more customers or potential customers. The microphone 314 detects customers or potential customers talking or making sounds at or near the vending machine 105 or sound produced by human traffic passing by or encountering the vending machine 105. The VMC 305, implementing the product recommendation engine, receives or records the sound detected by the microphone 314 and identifies or calculates a recommendation input from the sound. The VMC 305, implementing the product recommendation engine, uses the recommendations input from the microphone 314 to select and present a recommendation to a customer or a potential customer.

In certain embodiments, the vending machine 105 includes a plurality of communication interfaces 315 configured to enable communications with respective external systems or devices. The VMC 305 is coupled to and communicates with the communication interface 315. Therefore, the VMC 305 is communicably coupled to communications system 110 through the communications interface 315. The VMC 305 can communicate through a wireless data transfer, a local area network Internet communication, or through a port provided in the vending machine 105, such as Universal Serial Bus (“USB”). For example, the VMC 305 can receive content for display, a recommendation input, product information, a recommendation rule, a product selection menu, a payment selection menu, a product purchase display queue for displaying products that are selected for purchase, a transaction complete display queue for displaying products that have been purchased after completing a transaction, a recommendation, or the like through one or more USB ports via a USB-compatible storage medium in addition to, or as an alternative to, through the data communications system 110.

In certain embodiments, the vending machine 105 includes or is configured to couple with a speaker 316. The speaker 316 is configured to generate and project sound within a distance of the vending machine 105. The VMC 305 is coupled to and communicates with the speaker 316. Thus, when the speaker 316 receives audio data from the VMC 305, the speaker 316 generates and projects sound based on the audio data. In certain embodiments, the VMC 305, implementing the product recommendation engine, generates for audio output through the speaker 316 content as described herein. Additionally or alternatively, the speaker 316 provides an audio output in coordination with a visual output provided by a display screen of the user interface 215.

The VMC 305 is coupled to or includes another memory 325. While shown as separate from the VMC 305, the memory 325 may be implemented within the same integrated circuit as the VMC 305. In addition, the memory 325 and the display memory 320 may be included within a single memory unit, such as partitioned sectors within a single memory unit. The memory 325 may include any suitable volatile or non-volatile storage and retrieval device(s). For example, the memory 325 can include any electronic, magnetic, electromagnetic, optical, electro-optical, electro-mechanical, or other physical device(s) that can contain, store, communicate, propagate, or transmit information.

Additionally, the memory 325 can store information related to the object to which the VMC 305 is attached, such as product information, promotional information, product inventory, co-located vending machine status, event history, maintenance history, or the like. In certain embodiments, the memory 325 can store data and instructions for use by the VMC 305. For example, the memory 325 can store recommendation rules and trend inputs for use by the VMC 305 implementing the product recommendation engine. The memory 325 stores a workflow program 330 used to control the vending machine's operations during a vend transaction, a “shopping cart” data structure 335 used to hold product information from product tags (e.g., the product's Universal Product Code (“UPC”)) of product provided by the vending machine 105, and a recommendation table 340 is used to hold data for locating and presenting stored recommendations and may, in addition, store recommendations.

The memory 325 also stores a trend tracking program 345. The trend tracking program 345 contains a plurality of instructions or algorithms configured to cause the VMC 305 to store trend inputs, described herein, in the trend inputs memory 350. In certain embodiments, the trend tracking program 345 is integrated into the workflow program 330. In certain embodiments, the trend tracking program 345 receives trend inputs from the data processors 120 or the data warehouse 125 within the network operations center 115. In certain embodiments, the trend tracking program 345 causes the VMC 305 to retrieve the trend inputs from the data processors 120 or the data warehouse 125 within the network operations center 115. In certain embodiments, the trend tracking program 345 causes the VMC 305 to receive or retrieve the trend inputs from one or more other vending machines 105a through 105d. In certain embodiments, the trend tracking program 345 causes the VMC 305 to generate (e.g., calculate) the trend inputs prior to storage in trend input memory 350.

For example, the VMC 305 tracks and stores trends related to a rate of human traffic encountering the vending machine, a rate of sale of frequently selling products in order to sell down those frequently selling products faster, a rate of sale of slower selling products in order to sell down those products more evenly, a vending machine stocking schedule to sell down perishable products, a customer purchase history, or the like. The VMC 305 directs the trend tracking program 345 to store the trends as trend inputs in the trend input memory 350 for use by the VMC 305, implementing the product recommendation engine, to select or present a recommendation to a customer or a potential customer.

The VMC 305 is coupled to and communicates with one or more product dispensers 355 (e.g., helical coils, an X-Y product retrieval mechanism) and the payment system 220. The payment system 220 is optionally coupled to the communication interface 315, enabling communication with the communications system 110. The payment system 220 includes one or any combination of: a coin mechanism, a bill validator or recycler, a magnetic stripe card reader, a cashless payment device reader, such as a reader of fobs, tags, tokens, or quick-response codes (QR codes). The VMC 305 receives signals from and controls the operation of the product dispensers 355 and the payment system 220. For example, the product dispenser 355 provides to the VMC 305 an indication that a product has been dispensed. As another example, the payment system 220 provides a recommendation input to the VMC 305 in the form of a selection of a payment type, a selection of a credit or debit card brand for payment, or the like.

In certain embodiments, the VMC 305 is coupled to the payment system 220 through a multi-drop bus (“MDB”) 360 that is communicably coupled to a retrofit telemetry unit 365. The retrofit telemetry unit 365 accesses the signals and messages transmitted between the VMC 305 and payment system 220. The retrofit telemetry unit 365 is also communicably coupled to the connection between the VMC 305 and the display controller 310. The retrofit telemetry unit 365 accesses the signals and messages transmitted between the VMC 305 and the display controller 310. The retrofit telemetry unit 365 is optionally coupled to the communication interface 315, enabling communication with the communications system 110.

The ICR 370 includes a magnetic stripe reader, a card swipe reader, or a wireless, contactless cashless payment device reader. The ICR 370 and a payment system controller 375 communicate with the VMC 305 and other subsystems within or external to the vending machine 105 via a National Automatic Merchandising Association (NAMA) multi-drop bus (MDB), a Data Exchange (DEX) protocol communications channel, or both. The ICR 370 and the payment system controller 375 communicate with the VMC 305 and other subsystems within or external to the vending machine 105 to generate and display recommendations.

The VMC 305 includes processing circuitry for implementing the product recommendation engine to select and present (e.g., generate for presentation) one or more recommendations to a customer or a potential customer. Implementing the product recommendation engine, the VMC 305 receives one or more recommendation inputs, product information of one or more products, and one or more recommendation rules. As described herein, the VMC 305 uses the recommendation inputs, the product information, and the recommendation rules to select and present one or more recommendations to a customer or a potential customer.

The VMC 305, implementing the product recommendation engine, receives one or more recommendation inputs for use in selecting recommendations for presentation to a customer or a potential customer. In certain embodiments, the VMC 305, implementing the product recommendation engine, receives one or more recommendation inputs based on content displayed by user interface 215. For example, the VMC 305 receives a recommendation input during or after the user interface 215 displays content. As another example, the VMC 305 may receive a recommendation input in response to the substance of the content displayed on the user interface 215. A recommendation input is an external parameter received by the vending machine 105 or an internal parameter generated by or stored in the vending machine 105 that is received and used by the VMC 305, implementing the product recommendation engine, to select and present a recommendation. A recommendation input may include at least one of: one or more status inputs, one or more selection inputs, or one or more trend inputs.

A status input is an external status received by the vending machine 105 or an internal status generated by or stored in the vending machine 105 that is received and used by the VMC 305, implementing the product recommendation engine, to select a recommendation for presentation to a customer or a potential customer. A status input includes one or more of: a quantity of customers or potential customers standing within a distance of the vending machine 105 (e.g., viewing the user interface 215), an item in possession of one or more customers or potential customers standing within a distance the vending machine 105 (e.g., viewing the user interface 215), an indication of a holiday or an event, a current time of day, a current day of the week, a current month of the year, a current rate of human traffic encountering the vending machine 105, a decibel level of sound within a distance of the vending machine 105, a quantity of sources (e.g., customers, potential customers) producing sound within a distance of the vending machine 105, a current weather condition, a current forecasted weather condition, a geography in proximity to the vending machine 105, an update of product information of one or more products, a product price change (e.g. a product price percentage discount, a product price amount discount), a remaining quantity of each product stored in the vending machine 105, a remaining quantity of products stored in other vending machines within a specified distance from the vending machine 105, an indication that a product has been dispensed by one or more of the product dispensers 355 of the vending machine 105, an indication that a product has been removed from the access port 225 of the vending machine 105, or the like.

For example, the VMC 305 receives a first status input indicating that the current time of the day is 7:30 AM. Based on the first status input, the VMC 305, implementing the product recommendation engine, recommends a breakfast sandwich to a customer or a potential customer. Additionally, the VMC 305 receives a second status input indicating that ACME brand products are in a promotional period. Based on receiving the first status input and the second status input, the VMC 305, implementing the product recommendation engine, recommends an ACME brand breakfast sandwich to a customer or a potential customer.

Additionally, the VMC 305 receives a third status input indicating that a remaining quantity of ACME brand breakfast sandwiches stored in the vending machine 105 is low relative to a remaining quantity of GENERAL brand breakfast sandwiches stored in the vending machine 105. Based on the first status input, the second status input, and the third status input, the VMC 305, implementing the product recommendation engine, recommends a GENERAL brand breakfast sandwich to a customer or a potential customer to more evenly sell down products stored in the vending machine. Additionally, the VMC 305 receives a fourth status input indicating that a remaining quantity of ACME brand breakfast sandwiches stored in the vending machine 105 is low relative to a remaining quantity of ACME brand breakfast sandwiches stored in a nearby vending machine. Based on the first status input, the second status input, the third status input, and the fourth status input, the VMC 305, implementing the product recommendation engine, recommends an AMCE brand breakfast sandwich from the nearby vending machine to a customer or a potential customer to more evenly sell down products stored in a collection of vending machines. In certain embodiments, when recommending an AMCE brand breakfast sandwich from the nearby vending machine, the VMC 305, implementing the product recommendation engine, additionally provides directions or a map from the vending machine 105 to the nearby vending machine.

Additionally, the VMC 305 receives a fifth status input indicating that the customer or potential customer is holding a breakfast sandwich while standing in front of the vending machine. Based on the first status input, the second status input, the third status input, the fourth status input, and the fifth status input, the VMC 305, implementing the product recommendation engine, recommends orange juice or coffee to the customer or the potential customer to drink with their breakfast sandwich.

A selection input is an external input received by the vending machine 105 in response to a solicitation (e.g., from the vending machine 105) that is received and used by the VMC 305, implementing the product recommendation engine, to select a recommendation for presentation to a customer or a potential customer. A selection input includes one or more of: a language selected or spoken by a customer or a potential customer, a facial expression of one or more customers or potential customers viewing the user interface 215 of the vending machine 105 (e.g., as a reaction to display content), an image for presentation to the vending machine 105 (e.g., a picture of a product, a QR code), one or more spoken words or phrases within a distance of the vending machine 105 (e.g., as a reaction to display content), a received text input (e.g., received through the user interface 215), a response received when displaying a poll or an advertisement, a selection of a specific product or a specific group of products for purchase, a selection of a specific payment type, a selection of a specific debit or credit card brand, a selection of specific product information or product characteristics, a selection of a price point, a selection of a price range, a selection for recently discounted prices, a selection for new products, a command to complete a purchase from the vending machine 105, a refund request input, or the like.

For example, the VMC 305 receives a first selection input indicating the customer or the potential customer smiled when the touch screen displayed MOUNTAINTOP brand products. Based on receiving the first selection input, the VMC 305, implementing the product recommendation engine, recommends a pair of MOUNTAINTOP brand socks to a customer or a potential customer. Additionally, the VMC 305 receives a second selection input indicating that a customer has a preference for the color green over the color blue when displaying a poll. Based on the first selection input and the second selection input, the VMC 305, implementing the product recommendation engine, recommends a pair of green MOUNTAINTOP brand socks to a customer or a potential customer.

Additionally, the VMC 305 receives a third selection input indicating that the customer has recently selected sandals when viewing a selection menu. Based on the first selection input, the second selection input, and the third selection input, the VMC 305, implementing the product recommendation engine, recommends a green MOUNTAINTOP brand hat rather than a pair of socks. Additionally, the VMC 305 receives a fourth selection input indicating that the customer or potential customer has selected to use an ADAMS BANK brand debit card to purchase an item. Based on the first selection input, the second selection input, the third selection input, and the fourth selection input, the VMC 305, implementing the product recommendation engine, recommends a pair of gloves that may be purchased at a discounted price when using an ADAMS BANK brand debit card.

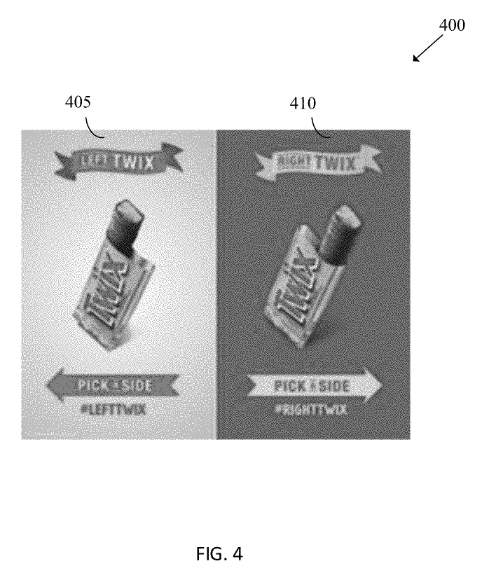

FIG. 4 illustrates a product selection menu 400 for display on a consumer user interface 215 according to embodiments of the present disclosure. Although certain details will be provided with reference to the components of a product selection menu 400 of FIG. 4, it should be understood that other embodiments may include more, less, or different components. The product selection menu 400 includes a first selection choice 405 and a second selection choice 410. The VMC 305, implementing the product recommendation engine, may receive a selection input of the first selection choice 405 when receiving a touch on the first selection choice 405. Alternatively, the VMC 305, implementing the product recommendation engine, may receive a selection input of the second selection choice 410 when receiving a touch on the second selection choice 410. Based on receiving a selection input of the first selection choice 405 or the second selection choice 410, the VMC 305, implementing the product recommendation engine, selects a recommendation for presentation to the customer or the potential customer.

A trend input is an external parameter or an internal parameter indicative of a trend, generated by (e.g., calculated by), received by, or stored in the vending machine 105, that is received and used by the VMC 305, implementing the product recommendation engine, to select a recommendation for presentation to a customer or a potential customer. A trend input includes one or more of: a rate of human traffic encountering the vending machine 105 (e.g., at a particular time, within a period of time), an indication of frequently selling products provided by the vending machine 105 (e.g., that may be used to sell down those frequently selling products faster), an indication of slower selling products provided by the vending machine 105 (e.g., that may be used to sell down the products provided by the vending machine 105 more evenly), an indication of a vending machine stocking schedule of the vending machine 105 (e.g., that may be used to sell down perishable products provided by the vending machine 105), an indication of frequently selling products provided by another vending machine, an indication of slower selling products provided by another vending machine, an indication of a vending machine stocking schedule of another vending machine, a customer purchase history (e.g., through a loyalty card, through a credit card, through a debit card), an indication of frequently selling products based on a type of people that encounter or pass by the vending machine (e.g., college students, mothers with small children, elderly people, teenagers, business men and women, vacationers, athletes), or the like.

For example, the VMC 305 receives a first trend input indicating that the vending machine 105 normally receives below average traffic at the current time of day. Based on receiving the first trend input, the VMC 305, implementing the product recommendation engine, recommends a discount on one or more products stored in the vending machine for a vending transaction. Additionally, the VMC 305 receives a second trend input indicating that WRIGHT brand headphones are the fastest selling item in the vending machine 105. Based on receiving the first trend input and the second trend input, the VMC 305, implementing the product recommendation engine, recommends WRIGHT brand headphones in order to sell down those frequently selling products provided by the vending machine 105 faster.

Additionally, the VMC 305 receives a third trend input indicating that ANSEL brand headphones are the slowest selling item in the vending machine 105. Based on receiving the first trend input, the second trend input, and the third trend input, the VMC 305, implementing the product recommendation engine, recommends the ANSEL brand headphones rather than the WRIGHT brand headphones in order to sell down products provided by the vending machine 105 more evenly. Additionally, the VMC 305 receives a fourth trend input indicating that the vending machine 105 is going to be restocked within the next twelve hours. Based on the first trend input, the second trend input, the third trend input, and the fourth trend input, the VMC 305, implementing the product recommendation engine, recommends both the WRIGHT brand headphones and the ANSEL brand headphones at discounts to sell down both products in the vending machine 105 faster.

Additionally, the VMC 305 receives a fifth trend input indicating that the customer or potential customer has previously purchased both WRIGHT brand headphones and ANSEL brand headphones. Based on the first trend input, the second trend input, the third trend input, the fourth trend input, and the fifth trend input, the VMC 305, implementing the product recommendation engine, recommends PINNACLE brand headphones as an alternative to both WRIGHT and ANSEL brand headphones.

The VMC 305, implementing the product recommendation engine, receives product information for use in selecting one or more recommendation for presentation to a customer or a potential customer. Product information is information associated with or related to a product stored in the vending machine 105 for a vending transaction, stored in another vending machine for a vending transaction, or available at a non-vending machine location that is received and used by the VMC 305, implementing the product recommendation engine, for selecting and presenting a recommendation. In certain embodiments, product information is associated with a “tag” (such a computer readable label or a unique identifier) of a particular product or of a particular group of products. For example, product information is associated with a product's Universal Product Code (“UPC”).

In certain embodiments, product information is stored on or with the tag. Additionally, or alternatively, product information is stored in the memory 325 (e.g., shopping cart 335) and the vending machine 105 uses a tag as a reference or a pointer to locate and retrieve product information stored in the memory 325 for the VMC 305. Product information includes one or more of: a product name, a product brand, a product price, a product price when purchased with one or more other products (e.g., a product price discount), a product price change history, a product category (e.g., food, clothing, electronics, electronic media, coupons, vouchers, passes, tickets), a product subcategory (e.g., smartphones, tablets, a digital movie, breakfast sandwiches, movie tickets, gloves, or shoes), a product characteristic (e.g., a quantity, a size, a number of servings, a compatibility with a device(s), a color, a shape, a style, a texture, a material, a calorie count, an ingredient, a health certification, a dietary certification), a payment type preference, a product identification number, a product expiration date, a product health-control flag, or the like.

The VMC 305, implementing the product recommendation engine, receives a recommendation rule to influence a selection of a recommendation or a presentation of a recommendation based on one or more received recommendation inputs and product information of one or more products. The VMC 305, implementing the product recommendation engine, selects and displays a recommendation based on one or more received recommendation inputs, product information of one or more products, and one or more recommendation rules.

A recommendation is a product suggestion that is presented to a customer or a potential customer of the vending machine 105. Recommendation may be stored in display member 320 or in memory 325 (e.g., the recommendation table 340). A recommendation is presented in the form of an image, a video, text, sound, a combination thereof, or the like. A recommendation includes one or more of: a suggestion to select for purchase one or more products from the vending machine, a suggestion to select for purchase one or more additional products from the vending machine, a suggestion to select for purchase one or more alternative products from the vending machine, a suggestion to select for purchase a combination of products from the vending machine, a suggestion to select for purchase one or more products from another vending machine, a suggestion to select for purchase one or more additional products from another vending machine, a suggestion to select for purchase one or more alternative products from another vending machine, a suggestion to select for purchase a combination of products from another vending machine, a suggestion to purchase or use one or more products not provided by a vending machine, a suggestion to purchase or use one or more additional products not provided by a vending machine, a suggestion to purchase or use one or more alternative products not provided by a vending machine, a suggestion to purchase or use a combination of products not provided by a vending machine, a combination thereof, or the like. In certain embodiments, a recommendation also includes a price change (e.g. a price discount) associated with purchasing or using a different or an additional one or more products.

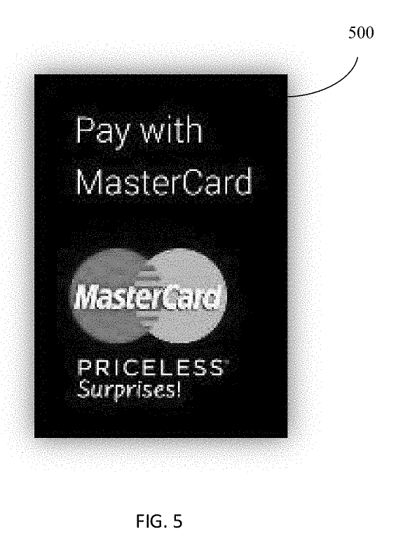

FIG. 5 illustrates a recommendation 500 for presentation to a customer or a potential customer of a vending machine 105 according to embodiments of the present disclosure. Although certain details will be provided with reference to the components of a recommendation 500 of FIG. 5, it should be understood that other embodiments may include more, less, or different components. The recommendation 500 includes a suggestion to consider using a MASTERCARD brand credit card. Thus, the VMC 305, implementing the product recommendation engine, may have received a recommendation presentation rule including a time parameter, described further herein, indicating that selected recommendations are to be displayed before the presentation of a payment selection menu. Thus, a customer or a potential customer may consider using a MASTERCARD brand credit card before choosing a payment type. In certain embodiments, a recommendation includes an incentive to purchase or use a suggested product. For example, the recommendation 500 may also include a 5% discount on all products purchased through the vending machine 105 using the MASTERCARD brand credit card.

A recommendation rule is a rule that is received by the VMC 305, implementing the product recommendation engine, and used to influence a selection of a recommendation or a presentation of a recommendation to the customer or the potential customer based on one or more recommendation inputs and product information of one or more products. Generally, a recommendation rule includes one or more of: a recommendation selection rule or a recommendation presentation rule. A recommendation selection rule influences the VMC 305, implementing the product recommendation engine, to match or associate a recommendation input with product information of one or more same or different products for the selection and presentation of one or more recommendations.

For example, a recommendation selection rule influences the VMC 305 to match or associate one or more of: a recommendation input with product information of one or more products provided by the vending machine 105, a recommendation input with product information of one or more products provided by another vending machine, a recommendation input with product information of one or more products not provided by a vending machine, a recommendation input with product information of one or more combinations of products provided by the vending machine 105, a recommendation input with product information of one or more combinations of products provided by another vending machine, a recommendation input with product information of one or more combinations of products not provided by a vending machine, or the like.

In certain embodiments, a recommendation selection rule influences the VMC 305, implementing the product recommendation engine, to match a recommendation input with product information of one or more same or different products for the selection of one or more recommendations. For example, the VMC 305, implementing the product recommendation engine, receives the term “CALIENTE” as a recommendation input. In response to receiving the recommendation input, the VMC 305, implementing the product recommendation engine, utilizes a recommendation rule including a recommendation selection rule that influences the VMC 305 to match the term “CALIENTE” with products having product information that includes the term “CALIENTE.” Thus, based on the recommendation rule including the recommendation selection rule, the VMC 305, implementing the product recommendation engine, selects for presentation a recommendation that includes a small bottle of CALIENTE brand hot sauce and a recommendation that includes a large bottle of CALIENTE brand hot sauce each of which have product brand names that includes the matched term “CALEINTE.”

In certain embodiments, a recommendation selection rule influences the VMC 305, implementing the product recommendation engine, to associate a recommendation input with product information of one or more same or different products for the selection of one or more recommendations. For example, the VMC 305, implementing the product recommendation engine, receives a selection of winter gloves as a recommendation input in response to displaying a selection menu. In response to receiving the recommendation input, the VMC 305, implementing the product recommendation engine, utilizes a recommendation rule including a recommendation selection rule that influences the VMC 305 to associate the product information of the winter gloves with a ski hat, ski goggles, and a coupon for a discount on ski lift tickets with the purchase of two or more of the winter gloves, the ski hat, or the ski goggles. Thus, based on the recommendation rule including the recommendation selection rule, the VMC 305, implementing the product recommendation engine, selects for presentation a recommendation that includes a ski hat, a recommendation that includes ski googles, and a recommendation that includes a coupon for a discount on ski lift tickets with the purchase of two or more of the winter gloves, the ski hat, or the ski goggles.

In certain embodiments, a single recommendation selection rule only influences the VMC 305 to match a recommendation input with product information of one or more same or different products. In certain embodiments, a single recommendation selection rule only influences the VMC 305 to associate a recommendation input with product information of one or more same or different products. In certain embodiments, a single recommendation selection rule influences the VMC 305 to match and associate a recommendation input with product information of one or more same or different products.

A recommendation presentation rule influences the VMC 305, implementing the product recommendation engine, to generate for presentation or to present one or more recommendations to a customer or a potential customer. In certain embodiments, a recommendation presentation rule includes a time parameter for influencing when the VMC 305 is to generate for presentation or is to present one or more recommendations, as described herein with respect to FIG. 4. A time parameter includes generating for presentation or presenting a recommendation: in response to receiving a recommendation input (e.g., a status input, a selection input), for a predetermined amount of time, at one or more predetermined time intervals, before the VMC 305 receives a selection input, before, during, or after content is displayed, after a product has been vended by the vending machine 105, a combination thereof, or the like.

For example, the VMC 305, implementing the product recommendation engine, receives a selection of winter gloves as a recommendation input in response to displaying a selection menu. In response to receiving the recommendation input, the VMC 305, implementing the product recommendation engine, utilizes a recommendation rule that influences the VMC 305 to associate the product information of the winter gloves with a ski hat, ski goggles, a coupon for a discount on ski lift tickets, and a coupon for ski lessons. The recommendation rule also includes a time parameter indicating that when the VMC 305, implementing the product recommendation engine, receives a selection of winter gloves for purchase as a recommendation input, the VMC 305 is to generate for presentation or present one or more recommendations while a display screen of the user interface 215 presents an image of the winter gloves that have been selected for purchase in a product purchase display queue. Thus, when the display screen presents an image of the winter gloves that have been selected for purchase in a product purchase display queue (e.g., to confirm with the customer that correct product has been selected for purchase), the display screen simultaneously presents, with the image of the winter gloves in the product purchase display queue, a recommendation that includes a ski hat, a recommendation that includes ski goggles, a recommendation that includes a coupon for a discount on ski lift tickets, and a recommendation that includes a coupon for ski lessons. In certain embodiments, a displayed recommendation may be selected for purchase and added to the product purchase display queue before completing a vending transaction.

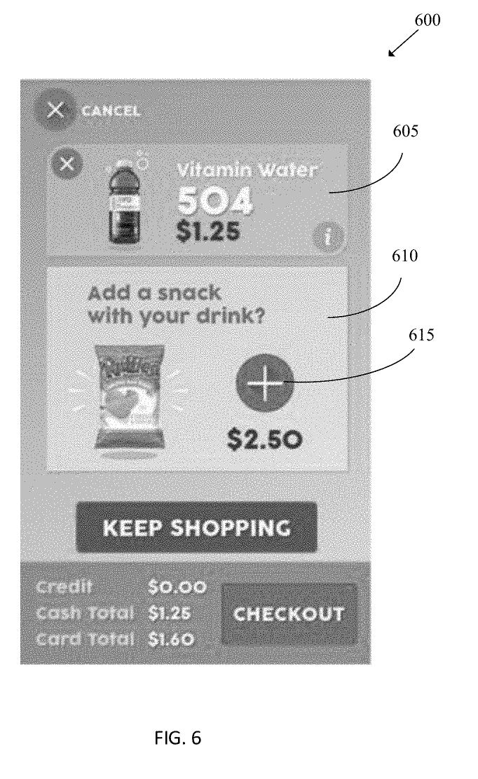

FIG. 6 illustrates a product purchase display queue 600 presented on a user interface 215 of a vending machine 105 according to embodiments of the present disclosure. Although certain details will be provided with reference to the components of a product purchase display queue 600 of FIG. 6, it should be understood that other embodiments may include more, less, or different components. The product purchase display queue 600 includes an image 605 of a product selected for purchase and a recommendation 610 of a suggested product for purchase. Thus, the VMC 305, implementing the product recommendation engine, may have received a recommendation presentation rule including a time parameter indicating that selected recommendations are to be displayed while the product purchase display queue 600 is displayed. As shown in FIG. 6, the recommendation 610 of the suggested product for purchase also includes a selection key 615 that when activated adds the recommended product into the product purchase display queue 600.

In certain embodiments, a recommendation presentation rule includes a format parameter for influencing how the VMC 305 is to generate for presentation or is to present one or more recommendations. A format parameter includes one or more of: a textual description of one or more recommendations, a font size, a font type, or a font characteristic of a textual description of one or more recommendation, a representative image of one or more recommendations, a size of a representative image of one or more recommendations, a displayed list of one or more recommendations, a series of fields or display screen sections with each field or section for presenting a recommendation or a recommendation combination, a series of fields or a series of display screen sections with each field or section for presenting a recommendation or a recommendation combination and with each field or section being associated with a product or a combination of products that have been selected for purchase, a sequential display of one or more individual recommendations, a sequential display of one or more recommendation combinations, a audibly recited description of one or more recommendations, a representative sound of one or more recommendations, or the like.

For example, the VMC 305, implementing the product recommendation engine, receives a selection of sun glasses as a first recommendation input and a selection of a beach towel as a second recommendation input. In response to receiving the recommendation inputs, the VMC 305, implementing the product recommendation engine, utilizes one or more recommendation rules that influence the VMC 305 to associate the product information of the sun glasses with sun screen and sun tan lotion and to associate the product information of the beach towel with a swim suit and sandals. The one or more recommendation rules also includes a format parameter indicating that when the VMC 305, implementing the product recommendation engine, receives a selection for purchase as first recommendation input and another selection for purchase as a second recommendation input, the VMC 305 is to generate for presentation or present one or more recommendations that the customer can associate with the first recommendation input and one or more recommendations that the customer can associate with the second recommendation input. Thus, when the display screen presents an image of the sun glasses that has been selected for purchase, the display screen also displays a recommendation that includes sun screen and a recommendation that includes sun tan lotion adjacent to the image of the sun glasses. Similarly, when the display screen presents an image of the beach towel that has been selected for purchase, the display screen also displays a recommendation that includes the swim suit and a recommendation that includes the sandals adjacent to the image of the beach towel.

Alternatively, when the VMC 305 is to generate for presentation or is to present one or more recommendations, the recommendation format parameter directs the VMC 305 to format the one or more recommendations in accordance with a format of a product purchase display queue or a format of a transaction complete display queue. For example, a product purchase display queue or a transaction complete display queue displays products using textual descriptions, displays products using a textual font size, font type, or font characteristic, displays a representative image of one or more products, displays a representative image having a specified size, displays representative images in a specified orientation, displays a list of one or more products, displays a series of fields or display screen sections with each field or section for presenting a product or a combination of products, displays one or more individual products or product combinations in a sequential order, audibly recites descriptions of one or more products, projects a representative sound of one or more products, a combination thereof, or the like. The VMC 305, implementing the product recommendation engine, receives a recommendation rule including a recommendation format parameter and aligns the format of a recommendation with a format of the product purchase display queue or the format of a transaction complete display queue based on the recommendation format parameter.

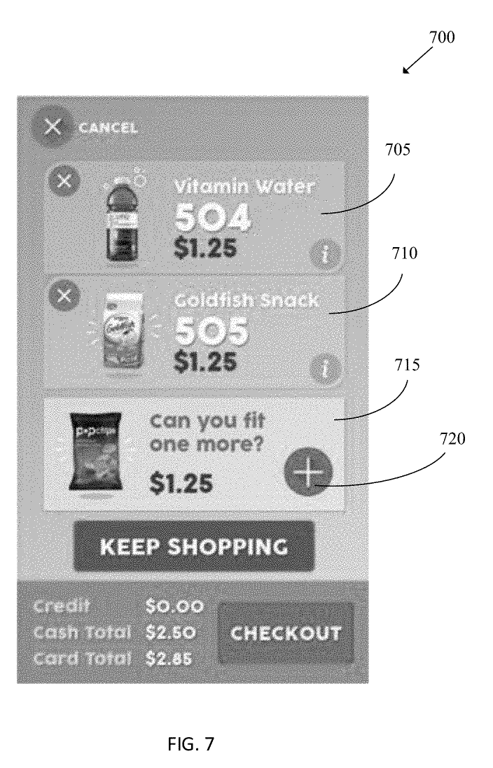

FIG. 7 illustrates a product purchase display queue 700 presented on a user interface 215 of a vending machine 105 according to embodiments of the present disclosure. Although certain details will be provided with reference to the components of a product purchase display queue 700 of FIG. 7, it should be understood that other embodiments may include more, less, or different components. The product purchase display queue 700 includes an image 705 of a first product selected for purchase, an image 710 of a second product selected for purchase, and a recommendation 715 of a suggested product for purchase. Thus, the VMC 305, implementing the product recommendation engine, may have received a recommendation presentation rule including a time parameter indicating that selected recommendations are to be displayed while the product purchase display queue 700 is displayed. In addition, the image 705, the image 710, and the recommendation 715 are arranged in a list format. Thus, the VMC 305, implementing the product recommendation engine, may have received a recommendation presentation rule including a format parameter indicating that selected recommendations are to be displayed in the format of the product purchase display queue 700. As shown in FIG. 7, the recommendation 715 of the suggested product for purchase also includes a selection key 720 that when activated adds the recommended product into the product purchase display queue 700.

In certain embodiments, a recommendation presentation rule includes a ranking parameter. A ranking parameter indicates an order or a hierarchy in which one or more selected recommendations are presented to a customer or a potential customer. A ranking parameter is indicative of where, when, or how a recommendation is presented relative to one or more other recommendations. For example, when a format parameter of recommendation presentation rule indicates a presentation format of a series of fields or a series of display screen sections on a display screen, a recommendation that has a first ranking is displayed in the most prominent field or the most prominent section on the display screen. Further, a recommendation that has a second ranking is displayed in a lesser prominent field or a lesser prominent section on the display screen. As another example, when a timing parameter of recommendation presentation rule indicates that a recommendation can be presented while an image of product that has been selected for purchase is presented and after an image of a product that has been selected for purchase is presented, a recommendation that has a first ranking is displayed while the image of the product that has been selected for purchase is presented. Further, a recommendation that has a second ranking is displayed after the image of the product that has been selected for purchase is presented. As yet another example, when a format parameter of recommendation presentation rule indicates a presentation format of a textual description of one or more recommendations, and a combination of a representative image and a textual description of one or more recommendation, a recommendation that has a first ranking is displayed with a representative image and a textual description. Further, a recommendation that has a second ranking is displayed only with a textual description.

A ranking parameter may rank one or more specified recommendations for presentation. For example, the VMC 305, implementing the product recommendation engine, receives a selection of winter gloves as a recommendation input in response to displaying a selection menu. In response to receiving the recommendation input, the VMC 305, implementing the product recommendation engine, utilizes a recommendation rule that associates the product information of the winter gloves with a ski hat, ski goggles, and a coupon for a discount on ski lift tickets with the purchase of two or more of the winter gloves, the ski hat, or the ski goggles. The recommendation rule also includes a ranking parameter indicating that when the VMC 305, implementing the product recommendation engine, receives the selection of winter gloves as a recommendation input, the VMC 305 is to assign a first ranking to the recommendation that includes the ski hat, a second ranking to the recommendation that includes the ski goggle, and a third ranking to the recommendation that includes the coupon for a discount on ski lift tickets with the purchase of two or more of the winter gloves, the ski hat, or the ski goggles.

Additionally, or alternatively, a ranking parameter may rank one or more recommendations for presentation based on matched or associated product information. For example, the VMC 305, implementing the product recommendation engine, receives a payment selection of a FIRST NOLDOVIA BANK debit card as a recommendation input in response to displaying a payment selection menu. In response to receiving the recommendation input, the VMC 305, implementing the product recommendation engine, utilizes a recommendation rule that associates or matches the product information of the FIRST NOLDOVIA BANK credit card with a coupon for a discount at the NOLDOVIA water park based on the term “NOLDOVIA” in the product names of both the FIRST NOLVDOVIA BANK credit card and the coupon for a discount at the NOLDOVIA water park. Also in response to receiving the recommendation input, the VMC 305, implementing the product recommendation engine, utilizes the recommendation rule that associates or matches the product information of the FIRST NOLDOVIA BANK credit card with an offer for a SUPER brand credit card based on both the FIRST NOLVDOVIA BANK credit card and the offer for the SUPER brand credit card share the same product category of “credit card.” The recommendation rule also includes a ranking parameter that assigns a higher rank to product category associations or matches than to product name associations or matches. Thus, the VMC 305, implementing the product recommendation engine, assigns a higher rank to the SUPER brand credit card than to the coupon for a discount at the NOLDOVIA water park.

Additionally, or alternatively, a ranking parameter may rank recommendations for presentation based on specific product information. For example, the VMC 305, implementing the product recommendation engine, receives a selection of winter gloves as a recommendation input in response to displaying a selection menu. In response to receiving the recommendation input, the VMC 305, implementing the product recommendation engine, utilizes a recommendation rule that associates the product information of the winter gloves with a ski hat, ski goggles, a coupon for a discount on ski lift tickets, and a coupon for ski lessons. The recommendation rule also includes a ranking parameter indicating that when the VMC 305, implementing the product recommendation engine, receives a selection of winter gloves as a recommendation input, the VMC 305 is to rank first a recommendation of a product for presentation having “coupons” as a product category and rank second a recommendation of a product for presentation having “clothing” as a product category. Thus, based on the recommendation rule including the ranking parameter, the VMC 305, implementing the product recommendation engine, ranks first the recommendation that includes a coupon for a discount on ski lift tickets and ranks second the recommendation that includes ski goggles.

As described herein, a recommendation rule is a rule that is received by the VMC 305, implementing the product recommendation engine, to influence a selection of a recommendation or a presentation of a recommendation to the customer or the potential customer based on one or more recommendation inputs and product information of one or more products. In certain embodiments, a recommendation rule includes a recommendation quantity rule. A recommendation quantity rule indicates a quantity parameter for selecting or for presenting one or more recommendations. A quantity parameter includes a maximum quantity (e.g. two (2) or more, at least three (3)), a minimum quantity (e.g. no more than five (5), does not exceed eight (8)), a quantity range (e.g., between two (2) and five (5), no more than seven (7) and no less than three (3)), or a specific quantity (e.g., one (1), five (5), ten (10)) of one or more recommendations that are to be selected for presentation or presented to one or more customers or potential customers.

For example, the VMC 305, implementing the product recommendation engine, receives the term “CALIENTE” as a recommendation input. In response to receiving the recommendation input, the VMC 305, implementing the product recommendation engine, utilizes a recommendation rule that matches or associates the term “CALIENTE” with one or more same or different products. The recommendation rule also includes a recommendation quantity rule indicating that when the VMC 305, implementing the product recommendation engine, receives the term “CALIENTE” as a recommendation input, the VMC 305, is to select for presentation or is to present no more than three (3) recommendation for presentation. Thus, based on the recommendation rule including the recommendation priority rule, the VMC 305, implementing the product recommendation engine, selects for presentation and presents a recommendation that includes a bottle of CALIENTE brand “mild” hot sauce, a recommendation that includes a bottle of CALIENTE brand “medium” hot sauce, and a recommendation that includes a bottle of CALIENTE brand “hot” hot sauce.\

In certain embodiments, a recommendation rule includes a recommendation priority rule. A recommendation priority rule indicates which one or more recommendations are prioritized over one or more other recommendations for selection and for presentation. A recommendation priority rule may prioritize one or more specified recommendations for presentation. For example, the VMC 305, implementing the product recommendation engine, receives the term “CALIENTE” as a recommendation input. In response to receiving the recommendation input, the VMC 305, implementing the product recommendation engine, utilizes a recommendation rule that matches or associates the term “CALIENTE” with one or more same or different products. The recommendation rule also includes a recommendation priority rule indicating that when the VMC 305, implementing the product recommendation engine, receives the term “CALIENTE” as a recommendation input, the VMC 305 is to prioritize specific recommendation for presentation: a recommendation that includes a small bottle of CALIENTE brand hot sauce, a recommendation that includes a large bottle of CALIENTE brand hot sauce, and a recommendation that includes a small bottle of CALIENTE brand green chili hot sauce.

Thus, based on the recommendation rule including the recommendation priority rule, the VMC 305, implementing the product recommendation engine, selects for presentation the recommendation that includes a small bottle of CALIENTE brand hot sauce, the recommendation that includes a large bottle of CALIENTE brand hot sauce, and the recommendation that includes a small bottle of CALIENTE brand green chili hot sauce. In addition, based on the recommendation rule including the recommendation priority rule, the VMC 305, implementing the product recommendation engine, also selects for presentation a recommendation that includes a large bottle of CALIENTE brand green chili hot sauce as long as the recommendation priority rule is satisfied.

Additionally, or alternatively, a recommendation priority rule may prioritize recommendations for presentation based on specific product information. For example, the VMC 305, implementing the product recommendation engine, receives a selection of winter gloves as a recommendation input in response to displaying a selection menu. In response to receiving the recommendation input, the VMC 305, implementing the product recommendation engine, utilizes a recommendation rule that associates the product information of the winter gloves with a ski hat, ski goggles, a coupon for a discount on ski lift tickets, and a coupon for ski lessons. The VMC 305 also receives a recommendation rule that includes a recommendation priority rule indicating that when the VMC 305, implementing the product recommendation engine, receives a selection of winter gloves as a recommendation input, the VMC 305 is to prioritize recommendations of products for presentation having “coupons” as a product category over recommendations of products for presentation having “clothing” as a product category. Thus, based on the recommendation priority rule, the VMC 305, implementing the product recommendation engine, selects for presentation a recommendation that includes a coupon for a discount on ski lift tickets and a recommendation that includes a coupon for ski lessons. In certain embodiments, the VMC 305, implementing the product recommendation engine, additionally selects for presentation a recommendation that includes a ski hat and a recommendation that includes ski goggles.

Additionally, or alternatively, a recommendation priority rule may prioritize recommendations for presentation based on a recommendation input type. For example, the VMC 305, implementing the product recommendation engine, receives a selection input and trend input. In response to receiving the selection input, the VMC 305, implementing the product recommendation engine, utilizes one or more recommendation rules to select and display one or more recommendations based on the selection input. In response to receiving the trend input, the VMC 305, implementing the product recommendation engine, utilizes one or more recommendation rules to select and display one or more recommendations based on the trend input. The VMC 305 also receives a recommendation rule that includes a recommendation priority rule that prioritizes recommendations based on selection inputs over recommendations based on trend input. Thus, based on the recommendation priority rule, the VMC 305, implementing the product recommendation engine, selects for presentation a recommendation based on the selection input over a recommendation based on the trend input.

Additionally, or alternatively, a recommendation priority rule may prioritize recommendations for presentation based on a specific recommendation input reception device or component. For example, the VMC 305, implementing the product recommendation engine, receives a status input in the form of a noise decibel level detected by a microphone 314 and selection input in the form a product selection received by a touch screen of the user interface 215. In response to receiving the noise decibel level from the microphone 314, the VMC 305, implementing the product recommendation engine, utilizes one or more recommendation rules to select and display one or more recommendations based on the noise decibel level detected by the microphone 314. In response to receiving the product selection received by the user interface 215, the VMC 305, implementing the product recommendation engine, utilizes one or more recommendation rules to select and display one or more recommendations based on the selection of the product received by the user interface 215. The VMC 305 also receives a recommendation rule that includes a recommendation priority rule that prioritizes recommendations based recommendation inputs received through the user interface 215 over recommendations based recommendation inputs received through the microphone 314. Thus, based on the recommendation priority rule, the VMC 305, implementing the product recommendation engine, selects for presentation a recommendation based on the selected product over a recommendation based on the noise decibel level.

Additionally, or alternatively, a recommendation priority rule may prioritize recommendations for presentation based on a specific recommendation input. For example, the VMC 305, implementing the product recommendation engine, receives a status input indicating that a specific product has received a price discount and a trend input indicating that another product is selling the slowest of all products in the vending machine 105. In response to receiving the status input indicating that the specific product has received a price discount, the VMC 305, implementing the product recommendation engine, utilizes one or more recommendation rules to select and display one or more recommendations based on the status input indicating that the specific product has received a price discount. In response to receiving the trend input indicating that another product is selling the slowest of all products in the vending machine, the VMC 305, implementing the product recommendation engine, utilizes one or more recommendation rules to select and display one or more recommendations based on the trend input indicating that another product is selling the slowest of all products in the vending machine. The VMC 305 also receives a recommendation rule that includes a recommendation priority rule that prioritizes recommendations based indications of a price discount over recommendations based indications of relatively slower selling products. Thus, based on the recommendation priority rule, the VMC 305, implementing the product recommendation engine, selects for presentation a recommendation based on the indication of the price discount over recommendations based the indication of the slowest selling product in the vending machine 105.

Additionally, or alternatively, a recommendation priority rule may prioritize recommendations for presentation based on a specified content type presented when a recommendation input was received. For example, the VMC 305, implementing the product recommendation engine, receives a selection input in the form of a facial expression received when displaying an advertisement and selection input in the form a product selection received when displaying a product selection menu. In response to receiving the facial expression, the VMC 305, implementing the product recommendation engine, utilizes one or more recommendation rules to select and display one or more recommendations based on the facial expression. In response to receiving the product selection, the VMC 305, implementing the product recommendation engine, utilizes one or more recommendation rules to select and display one or more recommendations based on the selected product. The VMC 305 also receives a recommendation rule that includes a recommendation priority rule that prioritizes recommendations based on recommendation inputs received when presenting a product selection menu over recommendations based recommendation inputs received when presenting an advertisement. Thus, based on the recommendation priority rule, the VMC 305, implementing the product recommendation engine, selects for presentation a recommendation based on the selected product over a recommendation based on the facial expression.

In certain embodiments, the VMC 305, implementing the product recommendation engine, may not be required to select for presentation or present a recommendation that satisfies a recommendation priority rule. For example, the VMC 305, implementing the product recommendation engine, receives a recommendation priority rule that prioritizes a recommendation that includes a small bottle of CALIENTE brand hot sauce, a recommendation that includes a large bottle of CALIENTE brand hot sauce, and a recommendation that includes a small bottle of CALIENTE brand green chili hot sauce. However, the VMC 305, implementing the product recommendation engine, also receives a recommendation input indicating that the vending machine 105 is sold out of small bottles of CALIENTE brand green chili hot sauce. The VMC 305, implementing the product recommendation engine, selects for presentation the recommendation that includes a small bottle of CALIENTE brand hot sauce, the recommendation that includes a large bottle of CALIENTE brand hot sauce, and a recommendation that includes a large bottle of CALIENTE brand green chili hot sauce based on the recommendation priority rule.

Even though the VMC 305, implementing the product recommendation engine, does not select for presentation the recommendation that includes a small bottle of CALIENTE brand green chili hot sauce, the VMC 305 still satisfies the recommendation priority rule because the recommendation that includes a small bottle of CALIENTE brand green chili hot sauce is prioritized over the recommendation that includes the large bottle of CALIENTE brand green chili hot sauce and but for the vending machine 105 being sold out of small bottles of CALIENTE brand green chili hot sauce, the VMC 305 would have selected for presentation the recommendation that includes the small bottle of CALIENTE brand green chili hot sauce.

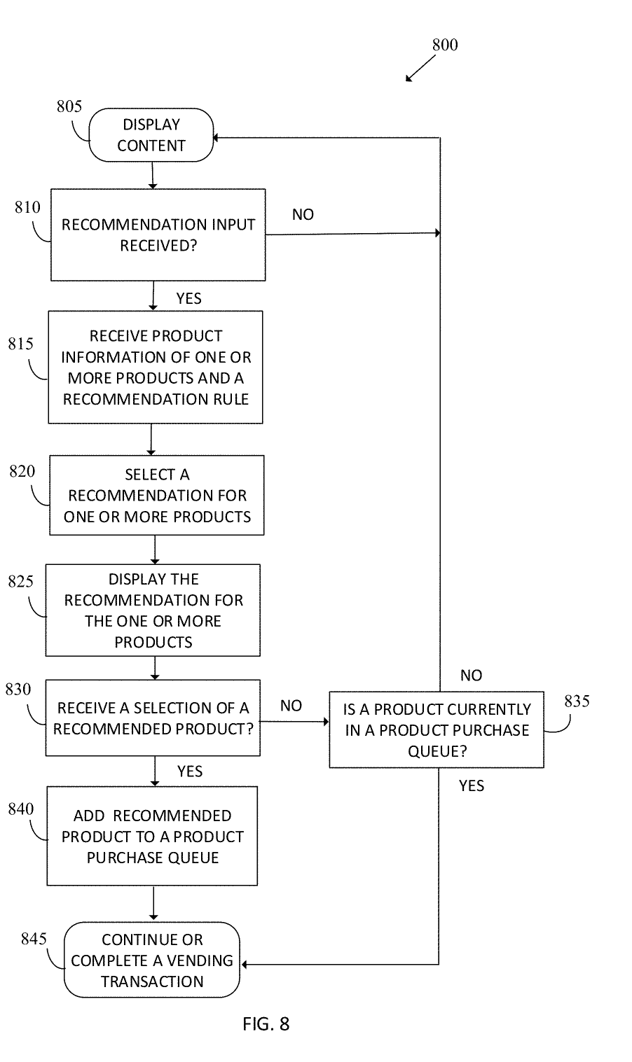

FIG. 8 illustrates a method 800 of providing a recommendation by a VMC 305, implementing a product recommendation engine, during operation of a vending machine 105 according to embodiments of the present disclosure. Although certain details will be provided with reference to the method 800 of FIG. 8, it should be understood that other embodiments may include more, less, or different method steps. At step 805, the VMC 305 generates for displays and displays content. Content includes a passive or an interactive advertisement, a poll, a product selection menu, a payment selection menu, a product purchase display queue for displaying products that have been selected for purchase, a transaction complete display queue for displaying products that have been purchased after completing a transaction, or the like. In certain embodiments, the content is displayed in response to one or more vending machine events, such as a customer contact, a tender of payment, a predetermined time of day, a dispensing operation, a refund operation, a promotional offer, or the like. In certain embodiments, the content is displayed in response to detecting an image or motion using an optical sensor 313

At step 810, the VMC 305 receives a recommendation input. A recommendation input is an external parameter received by the vending machine 105 or an internal parameter generated by or stored in the vending machine 105 that is received and used by the VMC 305, implementing the product recommendation engine, to select and present a recommendation. A recommendation input may include at least one of: one or more status inputs, one or more selection inputs, or one or more trend inputs. In certain embodiments, a selection input includes a selection of a product stored in the vending machine 105.

At step 815, the VMC 305 receives product information of one or more products and at least one recommendation rule. Product information is information associated with or related to a product stored in the vending machine 105 for a vending transaction, stored in another vending machine for a vending transaction, or available at a non-vending machine location that is received and used by the VMC 305, implementing the product recommendation engine, for selecting and presenting a recommendation. In certain embodiments, product information includes one or more of: a product name, a product brand, a product price, a product price when purchased with one or more other, a product price change history, a product category, a product subcategory, a product characteristic, a payment type preference, a product identification number, a product expiration date, a product health-control flag, or the like.

A recommendation rule is a rule that is received by the VMC 305, implementing the product recommendation engine, and used to influence a selection of a recommendation or a presentation of a recommendation to the customer or the potential customer based on one or more recommendation inputs and product information of one or more products. A recommendation rule includes one or more of: a recommendation selection rule or a recommendation presentation rule. A recommendation presentation rule influences the VMC 305, implementing the product recommendation engine, to generate for presentation or to present one or more recommendations to a customer or a potential customer.

At step 820, the VMC 305 selects one or more recommendations for one or more products. For example, the VMC 305 receives a recommendation selection rule that influences the VMC 305, implementing the product recommendation engine, to match or associate a recommendation input with product information of one or more same or different products for the selection and presentation of one or more recommendations. The VMC 305, implementing the product recommendation engine, uses the recommendation selection rule to select one or more recommendations that include products that have product information that is matched or associated with the received recommendation input. Selections of the recommendations based on recommendation inputs, product information, and recommendation rules allow the customers or potential customers to identify and chose products that may best fit or satisfy their needs or interests and allow venders to more efficiently and effectively target individuals most likely to buy products in the vending machine 105.

At step 825, the VMC 305 displays the one or more recommendations for the one or more products. For example, the VMC 305 receives a recommendation presentation rule that influences the VMC 305, implementing the product recommendation engine, to generate for presentation or to present one or more recommendations to a customer or a potential customer. The VMC 305, implementing the product recommendation engine, uses the recommendation presentation rule to present one or more recommendations at one or more vending stages, at one or more times, with one or more displays, in one or more specified formats, and in one or more particular orders or arrangements. Presentations of the recommendations, provided by the VMC 305, including the presentation timing, presentation display locations (e.g., on a product purchase display queue), presentation size, and presentation orders and arrangement allow the customer or potential customers viewing the recommendation to easily identify and chose products that may more suitably fit their needs or interests.

At step 830, the VMC 305, implementing the product recommendation engine, receives a selection of one or more recommended products. If the VMC 305 receives a selection of one or more of the recommended products, then at step 840, the VMC 305 adds the recommended product to a product purchase display queue. At step 845, the VMC 305, implementing the product recommendation engine, continues or complete the vending transaction. For example, the VMC 305, continuing the vending transaction, identifies the selection of the one or more recommended products as a recommendation input and repeats steps 810, 815, 820, 825, 830 and 845. As another example, the VMC 305, continuing the vending transaction, receives another recommendation input and repeat steps 810, 815, 820, 825, 830 and 845. Additionally or alternatively, the VMC 305 completes the vending transaction and vends one or more purchased products.

If the VMC 305, implementing the product recommendation engine, does not receive a selection of one or more products, then at step 835, the VMC 305 determines whether a product is in the product purchase display queue. If the VMC 305 determines that there is a product in the product purchase display queue, then at step 845, the VMC 305, implementing the product recommendation engine, may continue or complete the vending transaction as described herein. If the VMC 305 determines that there is not a product in the product purchase display queue, then at step 805, the VMC 305, implementing the product recommendation engine, displays content for a customer or a potential customer.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A vending machine, comprising:
an enclosure configured to store one or more products for a vending transaction;
a user interface configured to display, on a display screen, content for viewing by a customer and a recommendation for one or more products, the content including one or more of a poll, an advertisement, a product selection menu, a payment selection menu, a product purchase display queue, or a transaction complete display queue; and
a control system configured to:
receive at least one recommendation input based on displaying the content, product information of one or more products, and at least one recommendation rule, and
generate for display, on the display screen, the recommendation for one or more products based on the at least one recommendation input, the product information of the one or more products, and the at least one recommendation rule.

2. The vending machine according to claim 1, wherein the control system is configured to display, on the display screen, the recommendation for the one or more products while displaying one or more products selected by the customer based on the at least one recommendation rule.

3. The vending machine according to claim 1, wherein the control system is configured to display, on the display screen, the recommendation for the one or more products before or after displaying one or more products selected by the customer based on the at least one recommendation rule.

4. The vending machine according to claim 1, wherein the control system is configured to display, on the display screen, the recommendation for the one or more products at a location on the display screen adjacent a display of one or more products selected by a customer based on the at least one recommendation rule.

5. The vending machine according to claim 1, wherein the at least one recommendation input includes one or more of a status input, a selection input, or a trend input.

6. The vending machine according to claim 1, wherein the control system is further configured to select for display the recommendation for the one or more products based on a match or an association between the at least one recommendation input and the product information of the one or more products using the at least one recommendation rule.

7. The vending machine according to claim 1, wherein the control system is configured to generate for display, on the display screen, the recommendation for the one or more products in one or more of a list format, a series of fields or display screen sections format, or a sequential display format based on the at least one recommendation rule.

8. The vending machine according to claim 1, wherein the product information of the one or more products includes at least one of:
product information of one or more products stored in the enclosure of the vending machine,
product information of one or more products stored in an enclosure of another vending machine, or
product information of one or more products provided at a non-vending machine location.

9. A method, comprising:
storing one or more products for a vending transaction within an enclosure of a vending machine;
displaying content on a display screen of a user interface, the content including one or more of a poll, an advertisement, a product selection menu, a payment selection menu, a product purchase display queue, or a transaction complete display queue;
receiving at least one recommendation input based on displaying the content, product information of one or more products, and at least one recommendation rule; and
displaying a recommendation for one or more products based on the at least one recommendation input, the product information of the one or more products, and the at least one recommendation rule.

10. The method according to claim 9, wherein the recommendation for the one or more products is displayed while displaying one or more products selected by a customer.

11. The method according to claim 9, wherein the recommendation for the one or more products is displayed before or after displaying one or more products selected by a customer.

12. The method according to claim 9, wherein the recommendation for the one or more products is displayed at a location on the display screen adjacent a display of one or more products selected by a customer.

13. The method according to claim 9, wherein the at least one recommendation input includes one or more of a status input, a selection input, or a trend input.

14. The method according to claim 9, further comprising:
selecting for display the recommendation for the one or more products based on a match or an association between the at least one recommendation input and the product information of the one or more products using the at least one recommendation rule.

15. The method according to claim 9, wherein the recommendation for the one or more products is displayed in one or more of a list format, a series of fields or display screen sections format, or a sequential display format.

16. The method according to claim 9, wherein the product information of the one or more products includes at least one of:
product information of one or more products stored in the enclosure of the vending machine,
product information of one or more products stored in an enclosure of another vending machine, or
product information of one or more products provided at a non-vending machine location.

17. A vending machine, comprising:
an enclosure configured to store one or more products for a vending transaction;
a user interface configured to display, on a display screen, content for viewing by a customer and a recommendation for one or more products, the content including one or more of a poll, an advertisement, a product selection menu, a payment selection menu, a product purchase display queue, or a transaction complete display queue; and
a control system configured to:
receive at least one recommendation input based on displaying the content, product information of one or more products, and at least one recommendation rule, wherein one or more of the at least one recommendation input, the product information of the one or more products, or the at least one recommendation rule is received from a server via wireless communication with the vending machine, and
generate for display, on the display screen, the recommendation for one or more products based on the at least one recommendation input, the product information of the one or more products, and the at least one recommendation rule.

18. The vending machine according to claim 17, wherein the control system is configured to display, on the display screen, the recommendation for the one or more products at a location on the display screen adjacent a display of one or more products selected by a customer based on the at least one recommendation rule.

19. The vending machine according to claim 17, wherein the control system is further configured to select for display the recommendation for the one or more products based on a match or an association between the at least one recommendation input and the product information of the one or more products using the at least one recommendation rule.

20. The vending machine according to claim 17, wherein the product information of the one or more products includes at least one of:
product information of one or more products stored in the enclosure of the vending machine,
product information of one or more products stored in an enclosure of another vending machine, wherein the product information of the one or more products stored in the enclosure of the other vending machine is received from the other vending machine, or
product information of one or more products provided at a non-vending machine location.
